(19) United States
(12) Patent Application Publication
(10) Pub. No.: US 2003/0079127 A1
(43) Pub. Date: Apr. 24, 2003

(54) Method for protecting against theft the authenticating value of multiple application smart cards, smart cards therefor and terminals designed to receive said cards

(76) Inventors: Christophe Bidan, Thorigne-Fouillard (FR); Pierre Girard, La Ciotat (FR)

Correspondence Address: BURNS DOANE SWECKER & MATHIS L L P, POST OFFICE BOX 1404, ALEXANDRIA, VA, 22313-1404, US

(21) Appl. No.: 10/181,884

(22) PCT Filed: Jan. 18, 2001
(86) PCT No.: PCT/FR01/00165

(30) Foreign Application Priority Data
Jan. 24, 2000 (FR) 00/00829

(51) Int. Cl. H04L 9/00

(52) U.S. Cl. 713/172; 705/65

(57) ABSTRACT

The invention concerns a method for protecting against theft the authenticating value for multiple application smart cards. In order to prevent an application having access to a terminal from simulating the menu asking the user to present the authenticating value, the method provides a mechanism forcing access to the interface for presentation and verification of the authenticating value by the secure operating system whatever the application which has initiated the procedure, whenever there is a request for authenticating value. The invention is applicable to terminals (T) designed to communicate with smart cards (C) including therefor at least a function key (P_{IN}) or a sequence of function keys reserved for a system call to the card and to initiate presentation of the authenticating value.

The invention relates to a method for protecting against theft the authenticating value of multiple application smart cards able to communicate with the outside by means of a terminal. It also relates to smart cards using the said method and the terminals liable to receive the said cards. The invention applies particularly to multiple application smart cards used with mobile telephones such as the telephones defined by the GSM standard.

Multiple application smart cards means cards containing one or more integrated-circuit chips, the said cards being intended to be able to execute various application programs loaded or downloaded during the life of the card.

Amongst the solutions of multiple application cards existing at the present time, we can mention “JavaCard”specified by Sun or “SmartCard for Windows”specified by Microsoft.

To simplify, applications will be spoken of hereinafter in order to designate the application programs (or Applet in English terminology).

Authenticating value, also known as the authentication code, means a value making it possible to authenticate the holder of the card. The authenticating value can be a data item known to the holder alone (in general, a personal identification number or PIN number), derived from a biometric characteristic of the holder (for example voice, fingerprint, heat etc) or resulting from an action which only the holder can perform (for example signature).

For reasons of compatibility with smart cards which support only one application, and of simplicity for the user of the card, multiple application smart cards generally have only one authenticating value for all the applications. Thus the specification OP defined by VISA, which currently acts as a standard for the loading/downloading and internal management of applications on multiple application smart cards, specifies a single global PIN for all the resident and future applications of the card.

The problem raised by the applicant in the case of a multiple application card stems from the fact that the card is designed to be able to load or download new applications throughout its life. In principle this is an advantage, but in practice this characteristic makes the card vulnerable, since malevolent applications may be loaded with other applications in a manner which is transparent to the holder. This is therefore an open door for such applications which of course in practice will seek to discover the authenticating value of the card.

Following this observation, the applicant identified an attack making it possible to find the authenticating value of the card.

This attack assumes the existence of a malevolent application having access to the outside.

An application has access to a terminal provided that there is a terminal enabling the application to dialogue directly with the user via this terminal. It is possible to cite for example, in the context of GSM, the applications able to modify the menus displayed on the mobile telephone.

Here is then the procedure followed during this attack by means of an application which can dialogue with the outside.

In fact, the application uses its ability to dialogue with the outside in order to simulate on the terminal the interface which makes it possible to request the user to enter the authenticating value.

This is because the verification of the identity of the user of the card is generally effected by means of an application responsible for displaying, on the screen of the terminal in which the smart card is inserted, a menu inviting the user to present the authenticating value. Once the authenticating value is presented, the terminal returns this value to the said application, which checks (possibly by means of an application responsible for the verification of the authenticating value) that the value presented by the user is identical to the authentication value of the card. If such is the case, the application responds with affirmation; with negation in the contrary case.

Access to the application responsible for displaying, on the screen of the terminal in which the smart card is inserted, the menu inviting the user to present the authenticating value is generally controlled so that only the authorised applications can initiate the verification of the authenticating value.

Nevertheless, a malevolent application having access to a terminal can simulate on this terminal the menu inviting the user to present his authenticating value. The user will then present his authenticating value in complete confidence, thus enabling the malevolent application to discover this value. Subsequently the malevolent application will be able, by virtue of its ability to dialogue with the outside, to supply the authenticating value to the developer of the malevolent application. This will be all the easier in the case of a terminal such as a mobile telephone, from which the malevolent application will be able to dial a number in order to communicate the authenticating value.

The purpose of the present invention is to remedy these problems.

The object of the present invention is a method for protecting against theft the authenticating value of multiple application smart cards comprising an operating system, principally characterised in that it comprises, for preventing an application having access to a terminal from simulating the menu inviting the user to present the authenticating value, a mechanism forcing access to the interface presenting the authenticating value by the operating system of the card whatever the application which initiated the process, as soon as there is an authenticating value request.

According to another characteristic, the method includes the reservation on the terminal of at least one function key or a sequence of function keys able to provoke an invocation of the card operating system.

Implementation of the mechanism comprises the following sequence of actions:

pressing on the function key or keys by the user of the card in order to authorise the presentation of the authenticating value and cause a temporary blocking of the card applications,

presentation of the authenticating value,

implementation of the procedure for verifying the authenticating value by the operating system after the first two actions.

The invention also relates to a multiple application smart card comprising an operating system and means of communication with a terminal, principally characterised in that it comprises means so that the system calls coming from the terminal for the presentation of the authenticating value cannot be intercepted by the applications.

The invention relates to a terminal able to communicate with a smart card, principally characterised in that it comprises at least one function key or one sequence of function keys reserved for making a system call to the card and initiating the presentation of the authenticating value.

The terminal may be a mobile telephone, for example of the GSM type.

Other particularities and advantages of the invention will emerge clearly from a reading of the description given below and with regard to the drawings, in which:

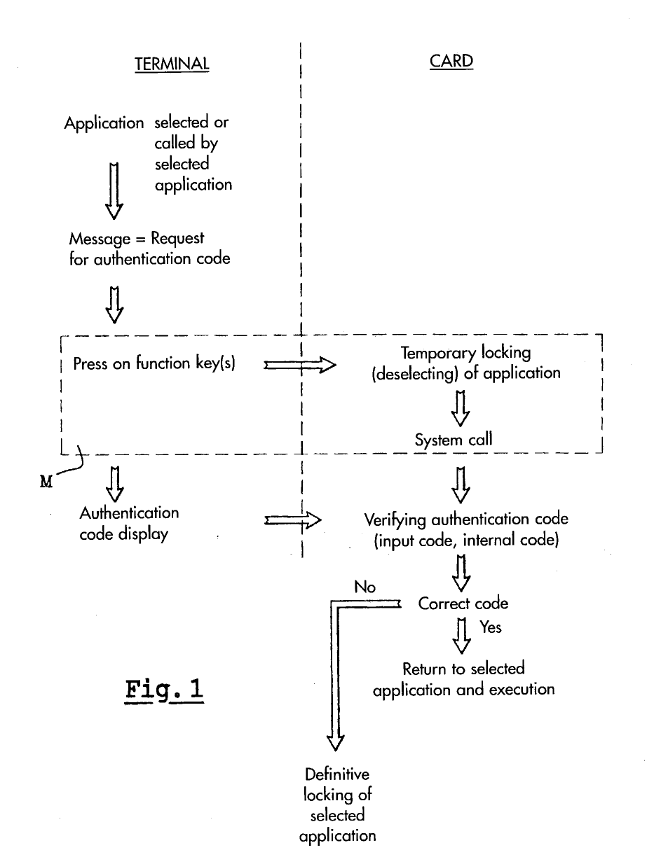

FIG. 1 depicts the diagram illustrating the implementation of the method according to the invention,

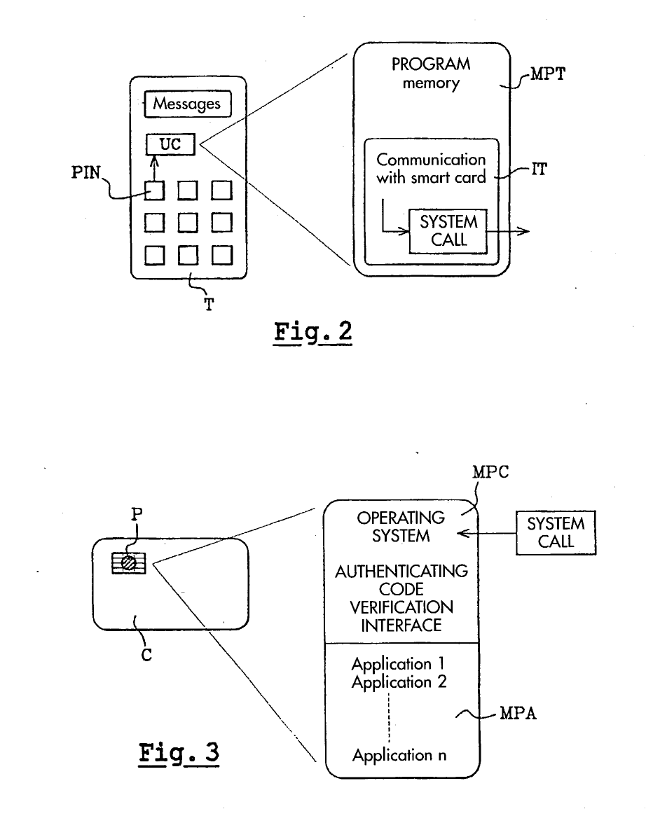

FIG. 2 depicts the diagram of a terminal able to communicate with a smart card according to the invention,

FIG. 3 depicts the diagram of a multiple application card according to the invention.

One practical embodiment of the method according to the invention will be described hereinafter with regard to FIG. 1.

The method comprises a temporary blocking of the application selected by the user or an application invoked by the application selected by this user; an invocation of the operating system of the smart card for the implementation by the operating system of the procedure for verifying the authenticating value.

According to the embodiment proposed, the blocking is obtained by the association of a function key or a sequence of keys provided on the terminal in order to be able to initiate the presentation of the authenticating value and a system call triggered by pressing this function key or the sequence of function keys. As soon as the user sees a message requesting the authenticating value appear on the screen of the terminal, he can continue the procedure of presenting the authenticating value only after having pressed the said key, in this way guaranteeing that the procedure for verifying the authenticating value is implemented by the operating system or under its control.

This is because, when an application is executed within the card and the menu for presenting the authenticating value appears on the screen of the terminal, the user can press on the function key provided bearing the reference P_{IN} in the diagrams (or on the sequence of function keys) in order to present his authenticating value. This action temporarily blocks the application currently being executed (that is to say the application is suspended) and a call is launched to the card operating system. It is then under the control of the operating system that the authenticating value presentation and verification procedure is implemented. This verification consists in comparing the authenticating value presented by the user with the authenticating value stored in the card.

When the authenticating value presented by the user is correct, the operating system of the card unblocks the application currently being executed, which can then resume its execution at the point at which it was suspended; in the contrary case, the operating system displays an error message and executes the appropriate security actions (for example definitively blocking the application and displaying an alert message).

FIG. 2 illustrates a terminal T able to communicate with a smart card. This terminal has in a known manner a central processing unit UC with a program memory MPT. This memory has an interface IT for communication with smart cards, conventional per se. Only one modification is provided to allow the terminal to await the pressing on the key P_{IN} (or the sequence of function keys) after display of the message requesting the authenticating value and to send a call to the card operating system.

A multiple application smart card C has been shown schematically in FIG. 3 in order to illustrate the various elements participating in the implementation of the method according to the invention. Let the case be taken, in order to simplify, where only one integrated-circuit card P is present in the card; this is a card containing one or more microprocessors and its associated memories, in particular a program memory MPC. This memory contains the operating system and the interface for presenting and verifying the authenticating value. In general, another program memory MPA is intended to store the various application programs A1, A2, . . . An.

1. A method for protecting against theft the authenticating value for a multiple application smart card having an operating system and an interface for presenting and verifying the authenticating value of the user of the said card, characterised in that it comprises, in order to prevent an application having access to a terminal from simulating the menu inviting the user to present the authenticating value, a mechanism forcing access to the interface for presenting and verifying the authenticating value by the operating system of the card whatever the application which initiated the process, as soon as there is a request for an authenticating value.

2. A method for protecting against theft the authenticating value according to claim 1, characterised in that the mechanism includes the reservation on the terminal of at least one function key or a sequence of several function keys able to cause an invocation of the card operating system.

3. A method for protecting against theft the authenticating value according to claim 1 or 2, characterised in that the implementation of the mechanism comprises the following sequence of actions:
pressing on the function or function keys by the user of the card in order to authorise the presentation of the authenticating value and cause a temporary blocking of the application,
the presentation of the authenticating value,
the implementation of the procedure for verifying the authenticating value by the operating system after the first two actions.

4. A multiple application smart card comprising an operating system and means of communicating with a terminal, characterised in that it comprises means (MPC) so that the system calls coming from the terminal (T) for the presentation of the authenticating value cannot be intercepted by the card applications.

5. A terminal able to communicate with a smart card according to claim 4 implementing a method for protecting against theft the authenticating value for the said smart card, characterised in that it comprises at least one function key (P_{IN}) or a sequence of function keys reserved for making a system call to the card and initiating the presentation of the authenticating value.

6. A terminal according to claim 5, characterised in that it consists of a mobile telephone.
